(19) United States
(12) Patent Application Publication
(10) Pub. No.: US 2021/0074162 A1
(43) Pub. Date: Mar. 11, 2021

(54) METHODS AND SYSTEMS FOR PERFORMING LANE CHANGES BY AN AUTONOMOUS VEHICLE

(71) Applicant: GM GLOBAL TECHNOLOGY OPERATIONS LLC, Detroit, MI (US)

(72) Inventors: Sayyed Rouhollah Jafari Tafti, Troy, MI (US); Pinaki Gupta, Novi, MI (US); Syed B. Mehdi, Southfield, MI (US); Praveen Palanisamy, Sterling Heights, MI (US)

(73) Assignee: GM GLOBAL TECHNOLOGY OPERATIONS LLC, Detroit, MI (US)

(21) Appl. No.: 16/564,550

(22) Filed: Sep. 9, 2019

(51) Int. Cl. G08G 1/16; B60W 30/12; B60W 30/09; B60W 40/04; B60W 30/02; B62D 15/02; B60W 30/095; B60W 30/18; B60W 10/20; G05D 1/02

(52) U.S. Cl. CPC G08G 1/167; B60W 30/12; B60W 30/09; B60W 40/04; B60W 30/025; B60W 30/16; B60W 30/095; B60W 30/18163; B60W 10/20; G05D 1/021; B60W 2750/308; B62D 15/0255

(57) ABSTRACT

Systems and methods are provided for controlling a vehicle. In one embodiment, a method includes: determining, by a processor, that a lane change is desired; determining, by the processor, a lane change action based on a reinforcement learning method and a rule-based method, wherein each of the methods evaluates lane data, vehicle data, map data, and actor data; and controlling, by the processor, the vehicle to perform the lane change based on the lane action.

### INTRODUCTION

The present disclosure generally relates to vehicles, and more particularly relates to methods and systems for autonomously performing lane changes under urgent conditions or dense traffic environments.

An autonomous vehicle is a vehicle that is capable of sensing its environment and navigating with little or no user input. An autonomous vehicle senses its environment using sensing devices such as radar, lidar, image sensors, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

While autonomous vehicles and semi-autonomous vehicles offer many potential advantages over traditional vehicles, in certain circumstances it may be desirable for improved operation of the vehicles. For example, autonomous vehicles or semi-autonomous vehicle recommend and perform lane changes. Some lane changes are performed to enhance the satisfaction of the user. For example, changing lanes in order to pass a slow-moving vehicle may be performed to enhance the user's satisfaction. Such lane changes that are not necessary but are performed to enhance the user's satisfaction are referred to as motivational lane changes. Other lane changes are performed to navigate the vehicle to a desired location, to merge onto a new road (e.g., on ramp or off ramp merging) or to navigate around abrupt obstacles. Such lane changes may be considered as urgent and may need to be performed in dense traffic environments. Timing of completing a lane change under such conditions is important. Interaction with other vehicles in the scene and predicting the motion of the other vehicles can be difficult.

Accordingly, it is desirable to provide improved systems and methods for performing lane changes by an autonomous or semi-autonomous vehicle. Furthermore, other desirable features and characteristics of the present disclosure will become apparent from the subsequent detailed description and the appended claims, taken in conjunction with the accompanying drawings and the foregoing technical field and background.

### SUMMARY

Systems and methods are provided for controlling a vehicle. In one embodiment, a method includes: determining, by a processor, that a lane change is desired; determining, by the processor, a lane change action based on a reinforcement learning method and a rule-based method, wherein each of the methods evaluates lane data, vehicle data, map data, and actor data; and controlling, by the processor, the vehicle to perform the lane change based on the lane action.

In various embodiments, the rule-based method includes one or more rules that are based on feasibility of control of the vehicle.

In various embodiments, the rule-based method includes one or more rules that are based on safety of control of the vehicle.

In various embodiments, the rule-based method includes one or more rules that are based on comfort of a user of the vehicle.

In various embodiments, the lane change action includes an identifier of a gap between at least two vehicles on the road and a timing for performing the lane change.

In various embodiments, the determining the lane change action comprises: determining the lane change action based on the reinforcement learning method; and determining that the lane change action satisfies constraints of the rule-based method.

In various embodiments, the method includes: determining that the lane change action does not satisfy at least one constraint of the rule-based method; and determining a second lane change action based on the rule-based method, and wherein the lane change action is set to the second lane change action.

In various embodiments, the method includes: determining that the second lane change action does not satisfy at least one rule of the rule-based method; and masking a gap associated with the lane change action from potential gaps; and re-determining the lane change action based on the reinforcement learning method and any remaining potential gaps.

In various embodiments, the method includes training the reinforcement learning method based on decisions made by the rule-based method.

In another embodiment a system includes: a non-transitory computer readable medium that stores a reinforcement learning method and a rule-based method that are each based on lane data, map data, vehicle data, and actor data; and a processor. The processor is configured to: determine that a lane change is desired; determine a lane change action based on the reinforcement learning method and the rule-based method; and control the vehicle to perform the lane change based on the lane action.

In various embodiments, the rule-based method includes one or more rules that are based on feasibility of control of the vehicle.

In various embodiments, the rule-based method includes one or more rules that are based on safety of control of the vehicle.

In various embodiments, the rule-based method includes one or more rules that are based on comfort of a user of the vehicle.

In various embodiments, the lane change action includes an identifier of a gap between at least two vehicles on the road and a timing for performing the lane change.

In various embodiments, the processor is configured to determine the lane change action by: determining the lane change action based on the reinforcement learning method; and determining that the lane change action satisfies constraints of the rule-based method.

In various embodiments, the processor is further configured to: determine that the lane change action does not satisfy at least one constraint of the rule-based method; and determine a second lane change action based on the rule-based method, and wherein the lane change action is set to the second lane change action.

In various embodiments, the processor is further configured to: determine that the second lane change action does not satisfy at least one constraint of the rule-based method; and mask a gap associated with the lane change action from potential gaps determined by the reinforcement learning method; and re-determine the lane change action based on the reinforcement learning method and any remaining potential gaps.

In various embodiments, the processor is further configured to train the reinforcement learning method based on decisions made by the rule-based method.

In various embodiments, the training is performed off-line based on the feedback from the UB agent.

In various embodiments, the processor is further configured to translate the lane change action into a trajectory data, and wherein the processor controls the vehicle based on the trajectory data.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having a lane change system, in accordance with various embodiments;

FIG. 2 is a dataflow diagram illustrating an autonomous driving system that includes the lane change system, in accordance with various embodiments;

FIG. 3 is a dataflow diagram illustrating the lane change system, in accordance with various embodiments; and

FIG. 4 is an illustration of an exemplary road scenario identified by the lane change system

FIG. 5 is a flowchart illustrating a method for performing a lane change that may be performed by the lane change system, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

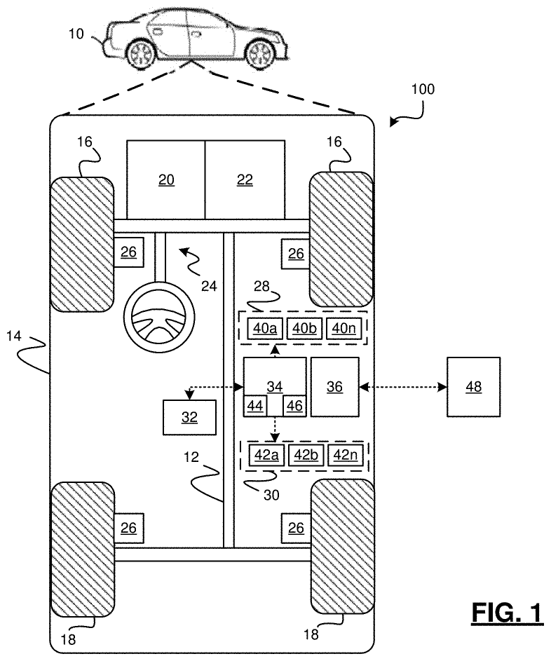

With reference to FIG. 1, a lane change system shown generally at 100 is associated with a vehicle 10 in accordance with various embodiments. In general, the lane change system 100 implements a hybrid planning approach for performing a lane change that is based on reinforcement learning (RL) and rule or utility-Based (UB) behavioral agents. For example, once a lane change is requested from a high-level route planner, a UB agent cooperates with a RL agent to select a target gap, defined by the space between vehicles in a target lane, and to define a timing required to accomplish the maneuver. As will be discussed in more detail below, once the gap and timing are defined and approved, the vehicle 10 is controlled to carry out the lane change.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the interpretation system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, or simply robots, etc., that are regulated by traffic devices can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. As can be appreciated, in various embodiments, the autonomous vehicle 10 can be any level of automation or have no automation at all (e.g., when the system 100 simply presents the probability distribution to a user for decision making).

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, inertial measurement units, and/or other sensors. In various embodiments, the sensing devices 40a-40n include one or more image sensors that generate image sensor data that is used by the interpretation system 100.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

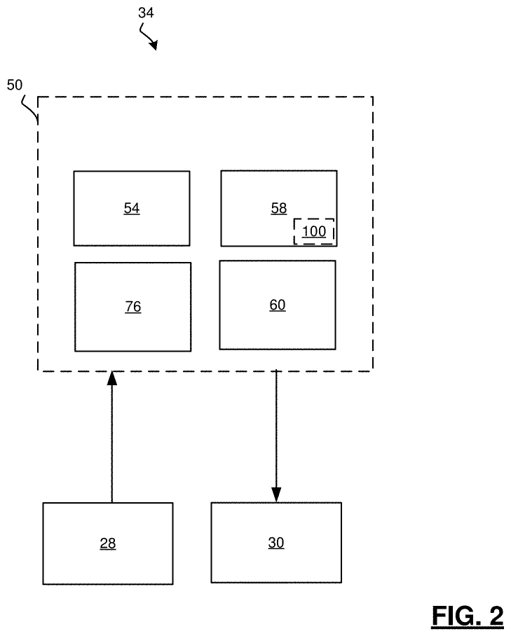

The communication system 36 is configured to wirelessly communicate information to and from other entities 48, such as but not limited to, other vehicles (“V2V” communication) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps are built from the sensor data of the vehicle 10. In various embodiments, the maps are received from a remote system and/or other vehicles. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied in the lane change system 100 and, when executed by the processor 44, perform a lane change based on reinforcement learning (RL) and rule or utility-based (UB) behavioral methods.

As can be appreciated, the subject matter disclosed herein provides certain enhanced features and functionality to what may be considered as a standard or baseline non-autonomous vehicle or an autonomous vehicle 10, and/or an autonomous vehicle based remote transportation system (not shown) that coordinates the autonomous vehicle 10. To this end, a non-autonomous vehicle, an autonomous vehicle, and an autonomous vehicle based remote transportation system can be modified, enhanced, or otherwise supplemented to provide the additional features described in more detail below. For exemplary purposes the examples below will be discussed in the context of an autonomous vehicle.

In accordance with various embodiments, the controller 34 implements an autonomous driving system (ADS) 50 as shown in FIG. 2. That is, suitable software and/or hardware components of the controller 34 (e.g., the processor 44 and the computer-readable storage device 46) are utilized to provide an autonomous driving system 50 that is used in conjunction with vehicle 10.

In various embodiments, the instructions of the autonomous driving system 50 may be organized by function, module, or system. For example, as shown in FIG. 2, the autonomous driving system 50 can include a computer vision system 54, a positioning system 56, a guidance system 58, and a vehicle control system 60. As can be appreciated, in various embodiments, the instructions may be organized into any number of systems (e.g., combined, further partitioned, etc.) as the disclosure is not limited to the present examples.

In various embodiments, the computer vision system 54 synthesizes and processes sensor data and predicts the presence, location, classification, and/or path of objects and features of the environment of the vehicle 10. In various embodiments, the computer vision system 54 can incorporate information from multiple sensors, including but not limited to cameras, lidars, radars, and/or any number of other types of sensors.

The positioning system 56 processes sensor data along with other data to determine a position (e.g., a local position relative to a map, an exact position relative to lane of a road, vehicle heading, velocity, etc.) of the vehicle 10 relative to the environment. The guidance system 58 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like. In various embodiments, the lane change system 100 of FIG. 1 may be included within the ADS 50, for example, as part of the guidance system 58.

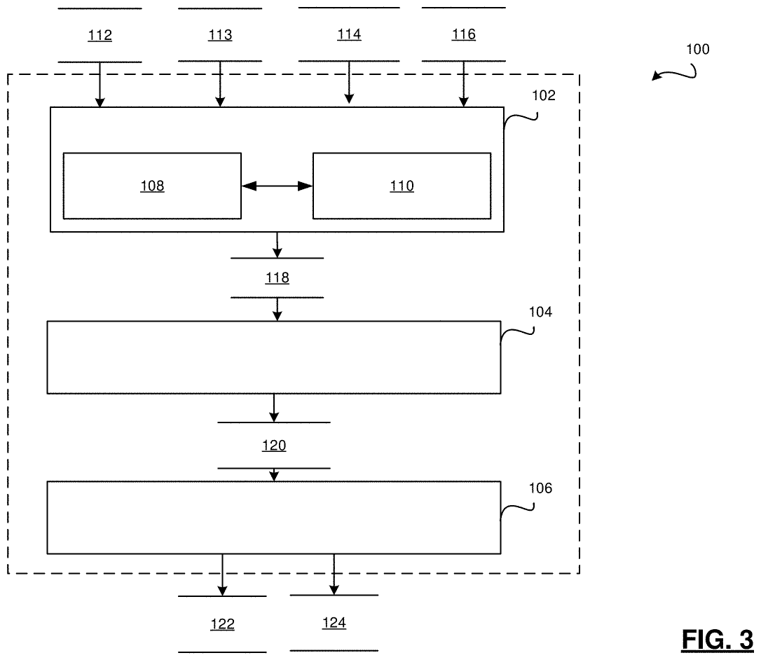

As shown in more detail with regard to FIG. 3 and with continued reference to FIGS. 1 and 2, the lane change system 100 may be implemented as functional modules. As can be appreciated, the functional modules shown and described may be combined and/or further partitioned in various embodiments. As shown the modules includes a behavioral control module 102, an action interpreter module 104, and a trajectory planner module 106.

The behavioral control module includes 102 a utility based (UB) agent 108 and a reinforcement learning (RL) agent 110. The UB agent 108 and the RL agent 110 cooperate to process lane change actions and generate action data 118 based thereon.

For example, the UB agent 108 performs UB based methods to generate lane change actions for different road scenarios based on pre-defined rules. The road scenarios can be determined based on lane data 112 indicating the lane configuration along the road, map data 113 including road information, host vehicle data 114 indicating the current operating conditions of the vehicle 10 (e.g., vehicle speed, acceleration, heading, position, etc.), and actor data 116 indicating current operating conditions of other vehicles or objects on the road (e.g., vehicle speed, acceleration, heading, position, etc.). The rules are defined, for example, to achieve feasibility, safety, and/or comfort for the user. For example, feasibility rules guarantee the continuity in the states of the host vehicle, such as continuity in position, velocity and acceleration. In another example, safety rules keep the host vehicle at a minimum safe distance from all actors on the road. In still another example, comfort rules, result in a vehicle motion which is within comfort thresholds for velocity, acceleration and jerk.

The RL agent 110 performs RL based methods to predict the lane change actions for the different road scenarios based on reinforcement learning. The road scenarios can similarly be determined based on the lane data 112, the host vehicle data 114, and the actor data 116. For example, the RL agent 110 may be implemented as a Markov decision process that includes:

a state space—a continuous n-dimensional vector space that includes host vehicle (Pₕ) and all actor information (Pₒ₁, Pₒ₂, . . . Pₒᵢ) in the scene;

an action space—m-dimensional vector comprising of selected gap id on the target lane (gapₜ) and time to reach target lanes (T_{Lk}, T_{LX}), where T_{Lk} is the lane keep maneuver time and T_{LX} denotes the lane change maneuver time; and

rewards—immediate rewards related to the feasibility of the generated immediate actions during the lane change and final delayed reward related to success of the whole lane change maneuver once completed.

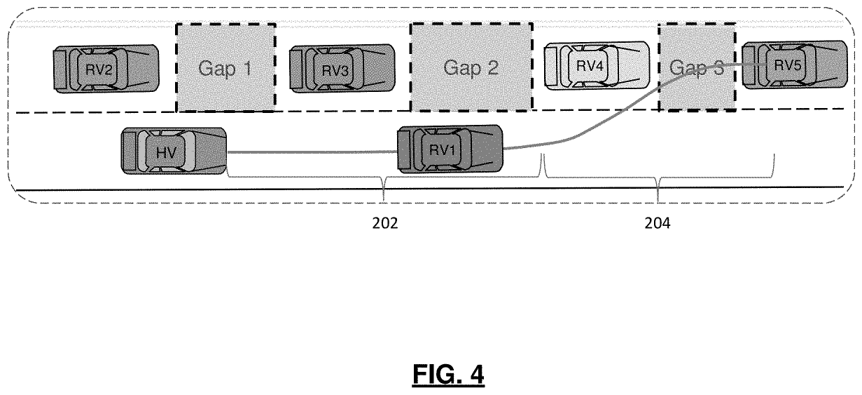

FIG. 4 illustrates an exemplary road scenario identified by the RL agent 110 including the host vehicle, the actor vehicles, the gaps, and the relative timing for lane keeping 202 and relative timing for lane changing 204.

In various embodiments, the behavioral control module 102 utilizes the RL agent 110 to determine a required action and utilizes the UB agent 108 to check for feasibility, safety, and comfort of the required action. If the required action does not meet any one of the feasibility, comfort, and safety requirements, then the behavioral control module 102 utilizes the UB agent 108 to determine the required action.

In various embodiments, the behavioral control module 102 trains the RL agent 110 based on the evaluations made by the UB agent 108. For example, rewards are computed for the RL agent 110 when the RL generated action meets feasibility, safety, or comfort requirements, and/or when the RL action is performed. In off-line training phase, performed in a simulation environment, the generated RL actions, are evaluated by the UB agent 108 to calculate the reward function values.

The action interpreter module 104 converts the actions into specific target goals 120 in terms of target position, velocity, and acceleration and time. The trajectory planner module 106 generates detailed spatial path data 122 and velocity profile data 124 for the vehicle's future motion. The data 122, 124 is then used by the control system 60 to control the vehicle 10 to perform the maneuver.

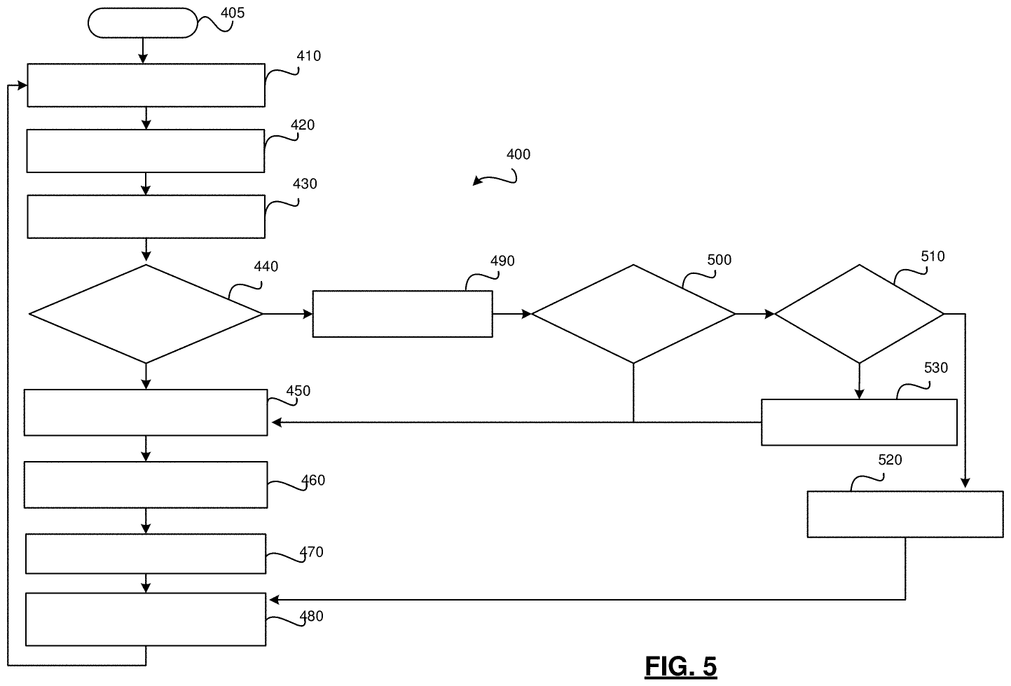

Referring now to FIG. 5 and with continued reference to FIGS. 1-3, a method 400 is shown in accordance with various embodiments. As can be appreciated, in light of the disclosure, the order of operation within the method 400 is not limited to the sequential execution as illustrated in FIG. 5 but may be performed in one or more varying orders as applicable and in accordance with the present disclosure. In various embodiments, one or more steps of the method 400 may be removed or added without altering the spirit of the methods 400.

In one embodiment, the method 400 may begin at 405. When an urgent lane change or merge is desired, the UB agent 108 invokes the RL agent 110 at 410. The RL agent 110 evaluates the current conditions and generates the optimal actions including the target gap, and the target timing (e.g., the LK time and the LX time) at 420 and provides the optimal action to the UB agent 108. The UB agent 108 evaluates the optimal action for feasibility, safety, and comfort at 430. When the optimal action is determined to be feasible, safe, and comfortable at 440, the UB agent 108 and the trajectory planner interpret the optimal actions at 450 and generate trajectory data to control the vehicle 10 to perform the action at 460.

Thereafter, the vehicle 10 is controlled based on the trajectory data at 470 and updated state data is received at 480. Thereafter, the method continues with invoking the RL agent 110 when an urgent lane change or merge is needed at 410.

However, when the optimal action is determined to be not feasible, not safe, or not comfortable at 440, the UB agent 108 determines an action for the target gap selected by RL agent 110 at 490. When the UB action is determined to be feasible, safe, and comfortable at 500, the UB agent 108 and the trajectory planner interpret the optimal actions at 450 and generate trajectory data to control the vehicle 10 to perform the action at 460.

Thereafter, the vehicle 10 is controlled based on the trajectory data at 470 and updated state data is received at 480. Thereafter, the method continues with invoking the RL agent 110 when an urgent lane change or merge is needed at 410.

However, when the UB agent 108 is unable to determine the UB action to be feasible, safe, and comfortable at 500, the UB agent 108 determines if all target gaps have been exhausted at 510. When all target gaps have not been exhausted at 510, the UB agent 108 masks that target gap at 520 and updated state data is received at 480. Thereafter, the method continues with invoking the RL agent 110 to generate another action which excludes the masked target gap at 520.

However, when the RL agent 110 fails to provide a safe action after visiting all target gaps at 500 and 510, the UB agent determines a lane following action at 530 until the RL agent 110 can come up with a new action in the next planning time. The RL agent 110 uses the feedback from the UB agent 108 to train the RL agent 110 to prevent future disagreements.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof

What is claimed is:

1. A method for controlling a vehicle, comprising:
determining, by a processor, that a lane change is desired;
determining, by the processor, a lane change action based on a reinforcement learning method and a rule-based method, wherein each of the methods evaluates lane data, map data, vehicle data, and actor data; and
controlling, by the processor, the vehicle to perform the lane change based on the lane action.

2. The method of claim 1, wherein the rule-based method includes one or more rules that are based on feasibility of control of the vehicle.

3. The method of claim 1, wherein the rule-based method includes one or more rules that are based on safety of control of the vehicle.

4. The method of claim 1, wherein the rule-based method includes one or more rules that are based on comfort of a user of the vehicle.

5. The method of claim 1, wherein the lane change action includes an identifier of a gap between at least two vehicles on the road and a timing for performing the lane change.

6. The method of claim 1, wherein the determining the lane change action comprises:
determining the lane change action based on the reinforcement learning method; and
determining that the lane change action satisfies constraints of the rule-based method.

7. The method of claim 6, further comprising:
determining that the lane change action does not satisfy at least one constraint of the rule-based method; and
determining a second lane change action based on the rule-based method, and
wherein the lane change action is set to the second lane change action.

8. The method of claim 7, further comprising:
determining that the second lane change action does not satisfy at least one rule of the rule-based method; and
masking a gap associated with the lane change action from potential gaps; and
re-determining the lane change action based on the reinforcement learning method and any remaining potential gaps.

9. The method of claim 1, further comprising training the reinforcement learning method based on decisions made by the rule-based method.

10. A system for controlling a vehicle, comprising:
a non-transitory computer readable medium that stores a reinforcement learning method and a rule-based method that are each based on lane data, map data, vehicle data, and actor data; and
a processor configured to:
determine that a lane change is desired;
determine a lane change action based on the reinforcement learning method and the rule-based method; and
control the vehicle to perform the lane change based on the lane action.

11. The system of claim 10, wherein the rule-based method includes one or more rules that are based on feasibility of control of the vehicle.

12. The system of claim 10, wherein the rule-based method includes one or more rules that are based on safety of control of the vehicle.

13. The system of claim 10, wherein the rule-based method includes one or more rules that are based on comfort of a user of the vehicle.

14. The system of claim 10, wherein the lane change action includes an identifier of a gap between at least two vehicles on the road and a timing for performing the lane change.

15. The system of claim 10, wherein the processor is configured to determine the lane change action by:
determining the lane change action based on the reinforcement learning method; and
determining that the lane change action satisfies constraints of the rule-based method.

16. The system of claim 15, wherein the processor is further configured to:
determine that the lane change action does not satisfy at least one constraint of the rule-based method; and
determine a second lane change action based on the rule-based method, and
wherein the lane change action is set to the second lane change action.

17. The system of claim 16, wherein the processor is further configured to:
determine that the second lane change action does not satisfy at least one constraint of the rule-based method; and
mask a gap associated with the lane change action from potential gaps determined by the reinforcement learning method; and
re-determine the lane change action based on the reinforcement learning method and any remaining potential gaps.

18. The system of claim 10, wherein the processor is further configured to train the reinforcement learning method based on decisions made by the rule-based method.

19. The system of claim 18, wherein the training is performed off-line based on the feedback from the UB agent.

20. The system of claim 10, wherein the processor is further configured to translate the lane change action into a trajectory data, and wherein the processor controls the vehicle based on the trajectory data.
